(19) United States
(12) Patent Application Publication
(10) Pub. No.: US 2016/0091440 A1
(43) Pub. Date: Mar. 31, 2016

(54) METHOD AND DEVICE FOR IMAGING AN OBJECT THROUGH PHOTONEUTRON TRANSMISSION

(71) Applicant: Nuctech Company Limited, Beijing (CN)

(72) Inventors: Yigang YANG, Beijing (CN); Qinjian Zhang, Beijing (CN); Yuanjing Li, Beijing (CN); Zhi Zhang, Beijing (CN)

(21) Appl. No.: 14/866,727

(22) Filed: Sep. 25, 2015

(30) Foreign Application Priority Data
Sep. 26, 2014 (CN) 201410500964.2

(51) Int. Cl. G01N 23/05; G01T 3/06

(52) U.S. Cl. CPC G01N 23/05; G01T 3/06

(57) ABSTRACT

The application relates to a method and device for imaging an object through photoneutron transmission. The method uses photoneutron rays to transmit the object, and comprises the following steps: emitting photoneutron rays by a photoneutron source to irradiate on the object; receiving the photoneutron rays from the photoneutron source by a detector; and imaging the object based on the photoneutron rays received by the detector; wherein the detector can slow down and absorb the photoneutrons, and wherein the incidence direction of the photoneutron rays from the photoneutron source and the normal direction of the detector surface form an angle ranging from 60 degrees to 87 degrees, or from about 60 degrees to about 87 degrees.

### CROSS-REFERENCE TO RELATED APPLICATION INFORMATION

This application claims the priority benefit of Chinese Patent Application No. 201410500964.2 filed on Sep. 26, 2014, published as ______, the contents of which being incorporated by reference herein in their entirety for all intended purposes.

### BACKGROUND

1. Field

This application relates to the field of transmission imaging technology, and in particular, relates to a method and device for imaging an object through photoneutron transmission.

2. Description of Related Information

When a photoneutron source generated by a linear electron accelerator is utilized to make transmission imaging, a problem of X-ray pulses interfering with photoneutron detection will arise. Since the photoneutron is a concomitant of the X-ray, and the intensity of the X-ray is much higher than that of the photoneutron (by about four to five orders of magnitude), even if a detector was very sensitive to neutrons and was very insensitive to photons, a signal amplitude of the X-ray pulses would still be much more than that of the photoneutron pulses, and it would result in that transmission imaging information obtained at this time is mainly from the contribution of X-ray pulses, rather than the photoneutrons.

Therefore, when the transmission imaging technology is utilized, a solution of “neutron moderator+neutron absorber” is provided in the prior art in order to eliminate the interference of X-ray pulses (e.g., see the patent application with publication No. CN102109473A). In this solution, a neutron moderator is utilized to slow down the photoneutrons that are incident on the detector, thereby the time of measuring the photoneutrons is delayed through the slowing-down process, so that the signal of the X-ray pulses has been disappeared in the detector when the photoneutrons are detected by the neutron absorber, thereby eliminating the interference of the X-ray pulses to the photoneutrons pulse signal. This method can be considered as a method of “trading time by space”, that is, the slowing-down process of the photoneutrons ensures that the photoneutrons are measured without the interference from the X-ray pulses. However, it also causes the problem that the incident positions of the photoneutrons are diffused and the absorption positions of the photoneutrons would be deviated from the original incidence points, which causes that the position resolution of the photoneutrons imaging technology is reduced.

### OVERVIEW OF SOME ASPECTS

According to an aspect of the present disclosure, a method for imaging an object through photoneutron transmission is provided, wherein the method uses photoneutron rays to transmit the object, and comprises: emitting photoneutron rays by a photoneutron source to irradiate on the object; receiving the photoneutron rays from the photoneutron source by a detector; and imaging the object based on the photoneutron rays received by the detector; wherein the detector can slow down and absorb the photoneutrons, and wherein the incidence direction of the photoneutron rays from the photoneutron source and the normal direction of the detector surface form an angle ranging from 60 degrees to 87 degrees.

According to another aspect of the present disclosure, a device for imaging an object through photoneutron transmission is provided, wherein the device uses photoneutron rays to transmit the object, and comprises: a photoneutron source configured to emit photoneutron rays to irradiate on the object; a detector configured to receive the photoneutron rays from the photoneutron source; and an imaging system configured to image the object based on the photoneutron rays received by the detector; wherein the detector can slow down and absorb the photoneutrons, and wherein the incidence direction of the photoneutron rays from the photoneutron source and the normal direction of the detector surface form an angle ranging from 60 degrees to 87 degrees.

### BRIEF DESCRIPTION OF THE DRAWINGS

FIG. 1A is a X-ray transmission image of an object in the prior art;

FIG. 1B is a photoneutron transmission image of the object of FIG. 1A in the prior art;

FIG. 2 is a flow diagram illustrating a method for imaging an object through photoneutron transmission according to an embodiment of the application;

FIG. 3 is a distribution diagram illustrating absorption positions of the photoneutrons with different incidence angles in a liquid scintillator containing boron according to an embodiment of the application;

FIG. 4 is a statistical diagram illustrating absorption positions of the photoneutrons with different incidence angles and the same incidence point in the X-direction in a liquid scintillator containing boron according to an embodiment of the application;

FIG. 5 is a schematic diagram illustrating a device for imaging an object through photoneutron transmission according to an embodiment of the application;

FIG. 6 is a schematic diagram illustrating the working principle of the photoneutron detector according an embodiment of the application; and

FIG. 7 is a schematic diagram illustrating a simulation result of the position resolutions of transmission imaging by different materials obtained by the photoneutron detector of FIG. 6 according to an embodiment of the application.

### DETAILED DESCRIPTION OF ILLUSTRATIVE IMPLEMENTATIONS

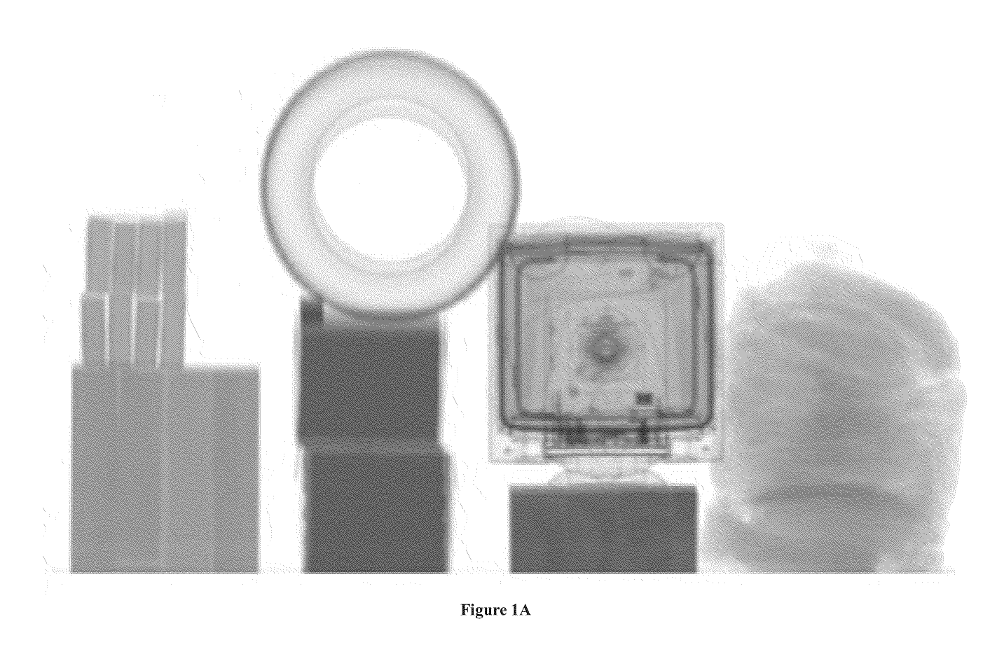

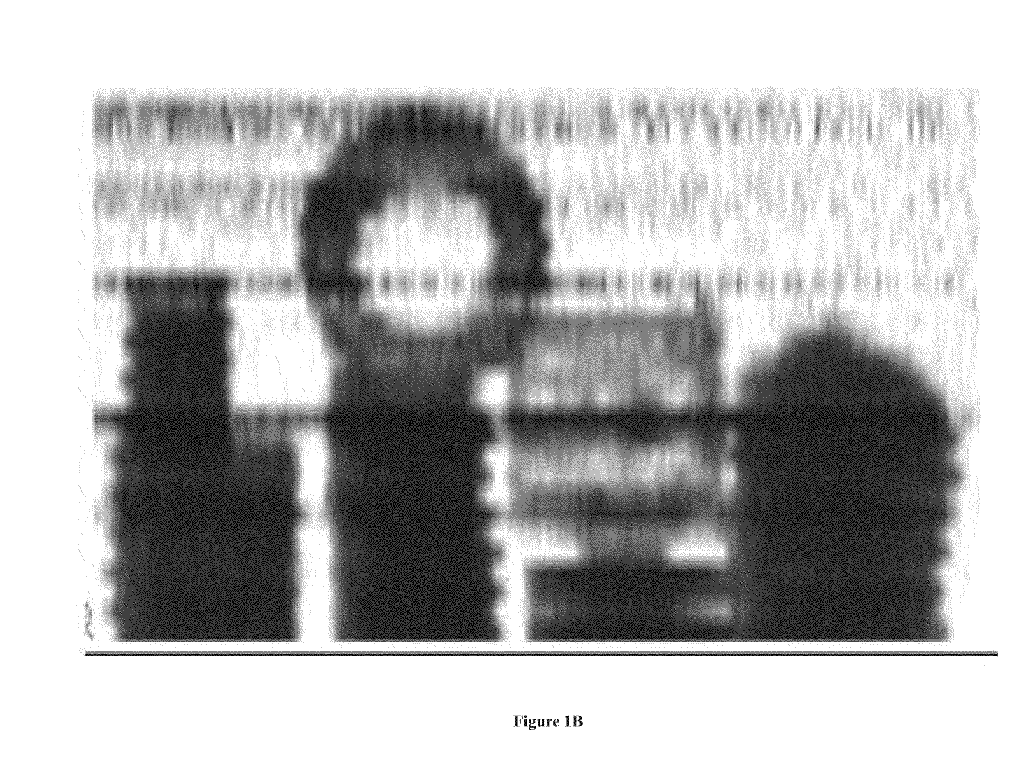

FIGS. 1A and 1B are respectively a X-ray transmission image and a photoneutron transmission image of a same object in the prior art. As shown in FIGS. 1A and 1B, the resolution of the photoneutron transmission image is worse than that of the X-ray transmission image.

The present disclosure provides a method and device for imaging an object through photoneutron transmission, which can improve the resolution. In the present disclosure, there is a technical precondition described below. When energy of the neutrons is not very high (e.g., several MeVs or less, the energy of photoneutrons falls within this energy range), the elastic scattering occurs between the neutrons and the protons in S-wave collision. In center of mass system, S-wave collision results in that the directions of scattering neutrons are isotropic. Therefore, after one collision, it can be believed that the neutron has lost “memory” of the incidence direction. Therefore, it can be approximately considered that the scattering process of the neutrons is almost the same in a moderator regardless of the way the neutrons are incident on a surface of the moderator.

The method and device for imaging an object through photoneutron transmission provided in the embodiments of the present disclosure will be described in detail in conjunction with accompanying drawings.

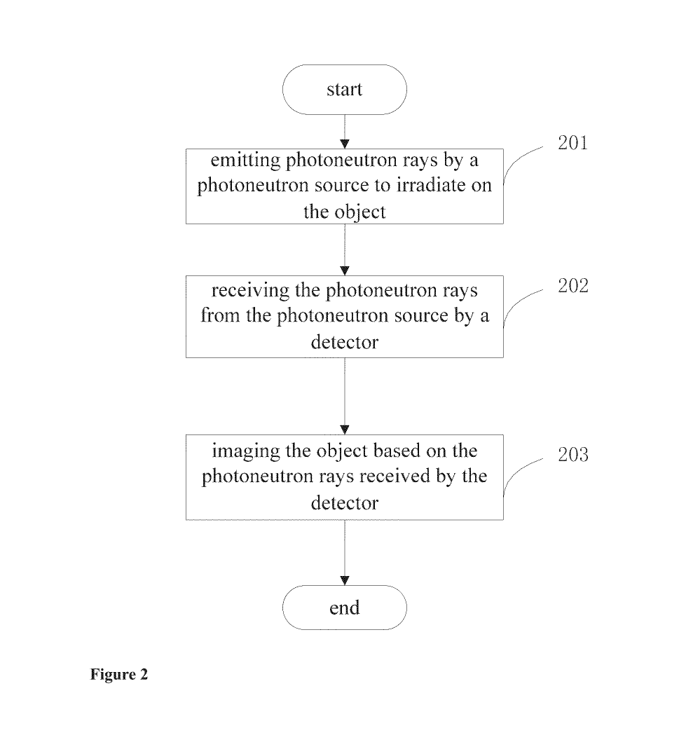

FIG. 2 is a flow diagram illustrating a method for imaging an object through photoneutron transmission according to an embodiment of the application. As shown in FIG. 2, the method comprises:

at 201, emitting photoneutron rays by a photoneutron source to irradiate on the object;

at 202, receiving the photoneutron rays from the photoneutron source by a detector; and

at 203, imaging the object based on the photoneutron rays received by the detector.

In one embodiment, the detector can slow down the photoneutrons and absorb the photoneutrons, and wherein the incidence direction of the photoneutron rays from the photoneutron source and the normal direction of the detector surface form an angle ranging from 60 degrees to 87 degrees.

In one embodiment, the incidence direction of the photoneutron rays from the photoneutron source and the normal direction of the detector surface form an angle ranging from 70 degrees to 80 degrees.

In one embodiment, the incidence direction of the photoneutron rays from the photoneutron source and the normal direction of the detector surface form an angle of 78 degrees.

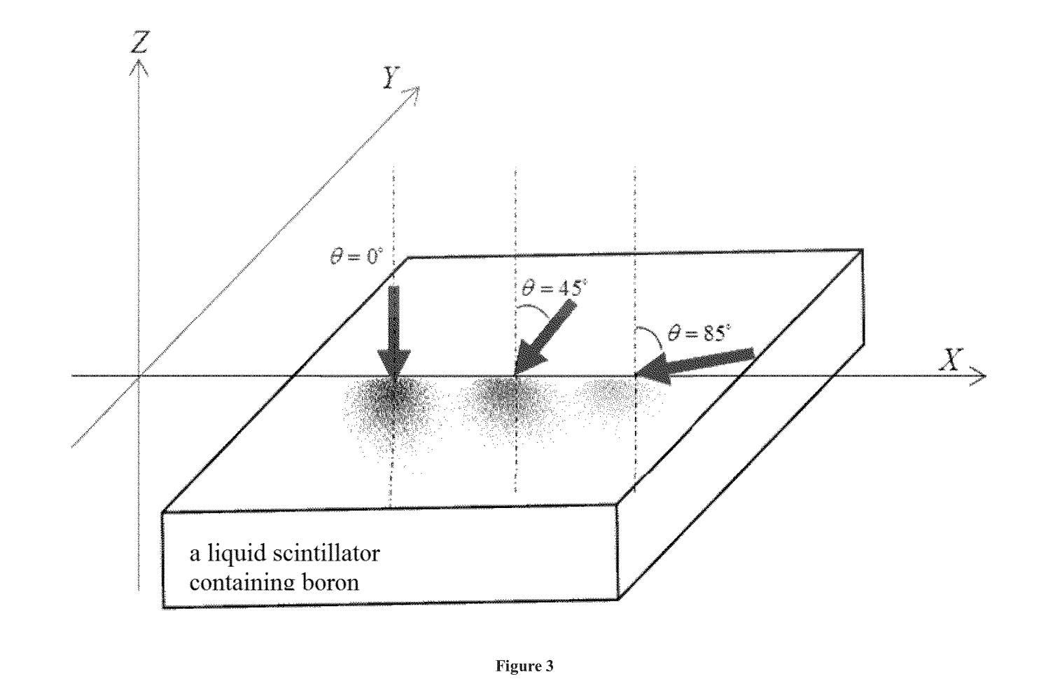

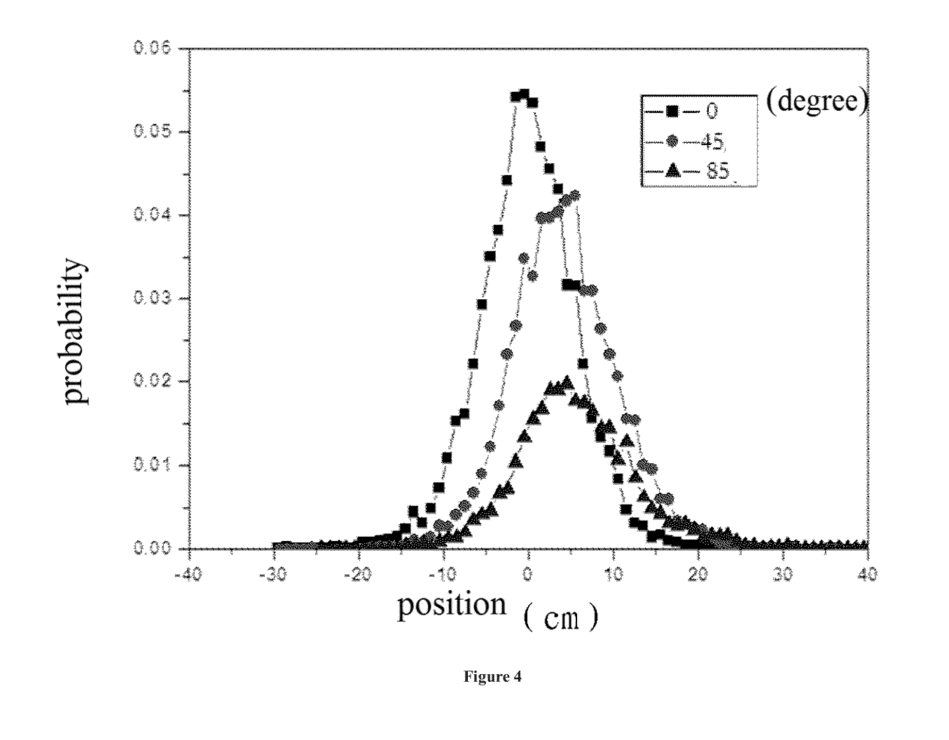

FIG. 3 is a distribution diagram illustrating absorption positions of the photoneutrons with different incidence angles in a liquid scintillator containing boron according to an embodiment of the application. FIG. 3 shows the absorption positions of the photoneutrons with three different incidence angles in the liquid scintillator containing boron (e.g., 0 degrees, 45 degrees, 85 degrees, each of which is an angle formed with respect to the normal direction of the surface of the liquid scintillator containing boron). Additionally, FIG. 4 illustrates a statistical diagram illustrating absorption positions of the photoneutrons with different incidence angles and the same incidence point in the X-direction in a liquid scintillator containing boron.

As can be seen from FIGS. 3 and 4, the absorption positions of the neutrons do not have a large discrete difference, no matter how the incidence angles change. In the three cases as shown in FIG. 4, the neutron absorbing positions distributed in the X direction have a standard deviation of 5.7 cm, 6.3 cm and 6.9 cm.

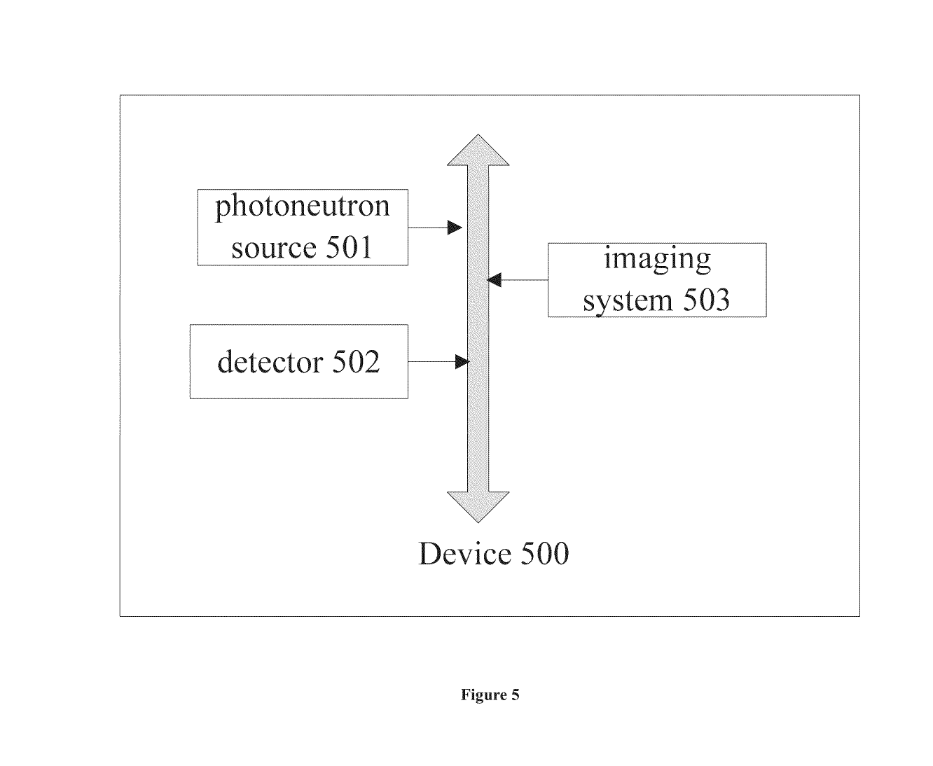

FIG. 5 is a schematic diagram illustrating a device 500 for imaging an object through photoneutron transmission according to an embodiment of the application. As shown in FIG. 5, the device 500 comprises a photoneutron source 501, a detector 502 and an imaging system 503, wherein the photoneutron source 501 emits photoneutron rays for irradiating on the object, the detector 502 receives the photoneutron rays from the photoneutron source, and the imaging system 503 images the object based on the photoneutron rays received by the detector. In the disclosure, the imaging system 503 has the same structure and working principle with that in the prior art, and thus the detailed description of the imaging system 503 is omitted herein. Furthermore, the key of the disclosure lies in the structure and arrangement of the detector.

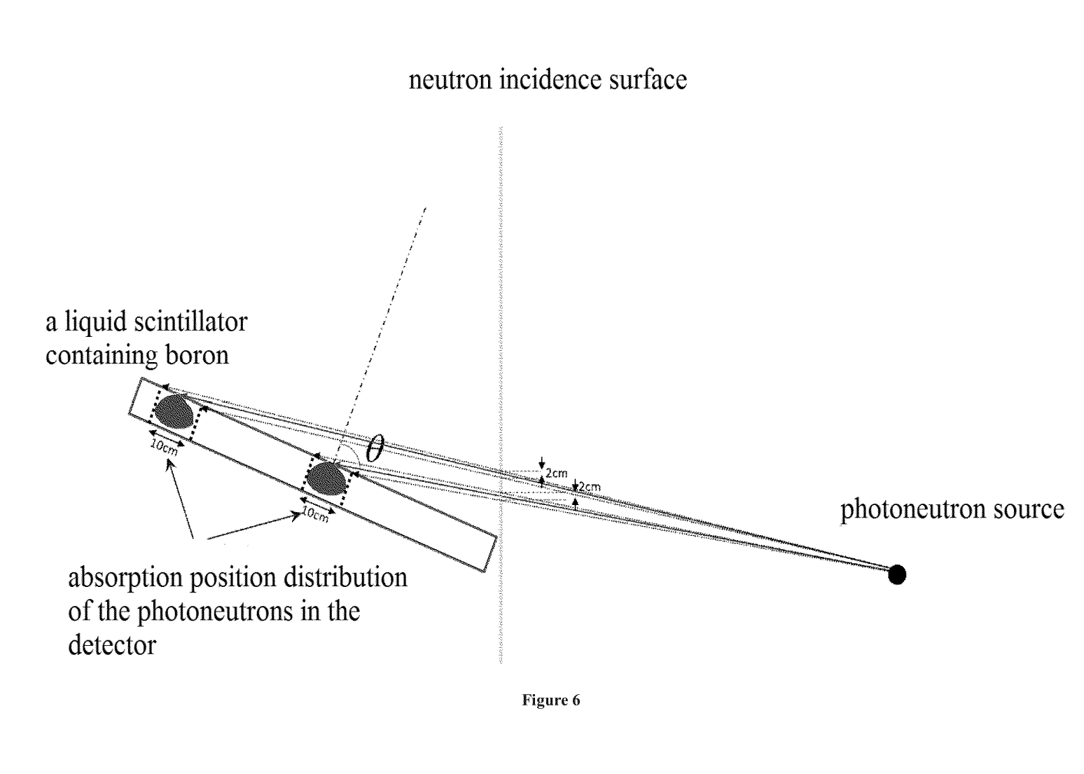

Based on the foregoing physical basis, the inventors of the present disclosure have contemplated the principle of the photoneutron detector shown in FIG. 6 of the present disclosure. FIG. 6 is a schematic diagram illustrating the working principle of the photoneutron detector according an embodiment of the application. In FIG. 6, the photoneutron detector can slow down and absorb the photoneutrons, for example, by using the liquid scintillator containing boron to slow down and absorb neutrons. Furthermore, it also can be a scintillator that contains other neutron absorption nuclides, such as ¹⁰B, ⁶Li, ¹⁵⁵Gd or ¹⁵⁷Gd. As shown in FIG. 6, the incidence direction of the photoneutrons from the photoneutron source (the incidence direction of the photoneutron rays) does not face the liquid scintillator containing boron in a head-on way, but forms an angle θ with the normal direction of the incidence surface of the liquid scintillator containing boron, wherein the angle θ falls within a predetermined range, and the angle θ will change as the incidence direction of the photoneutrons changes (since the photoneutron source is a point source, and the source detection distance is not infinite). However, in general, the angle θ used in the disclosure is maintained at about 78 degrees so that the value of cos θ is approximately equal to ⅕. In the present disclosure, discreteness of the absorption positions of the photoneutrons in the detector is reduced to about ⅕ of the original value after projection (projection of the detector surface on the neutron incidence surface). That is, as shown in FIG. 6, the imaging is performed by projecting the various absorption positions of the photoneutrons onto the neutron incidence surface (the position of the neutron incidence surface as shown in FIG. 6 is an assumed position for easy viewing; in fact, this position can be located on other place). As can be seen from FIG. 6, since cos θ is about equal to ⅕, after the absorption positions of the photoneutrons in the detector are projected onto the neutron incidence surface, the size of each of the absorption positions is decreased from 10 cm to 2 cm, that is, the size of each of the absorption positions on the neutron incidence surface is about 2 cm. Since the number of photoneutrons actually absorbed on the absorption positions is not changed, and the size of each absorption position is changed from 10 cm to 2 cm, the resolution of the detector is improved (i.e., the absorption position of the photoneutron in the detector is changed to 2 cm after being projected, and thus the resolution has increased by 5 times).

Furthermore, the above effect can be achieved as long as the above angle θ is located within a range from 60 degrees to 87 degrees; preferably, the angle θ is in the range of 70 degrees to 80 degrees; more preferably, the angle θ is 78 degrees.

In addition to the above, the system and method for imaging an object through photoneutron transmission provided in the present disclosure is similar to the prior art, but have the above features different from the prior art.

Specifically, in the method for imaging an object through photoneutron transmission provided by the present disclosure, firstly, a photoneutron source is activated to emit photoneutron rays and irradiate on a detected object (i.e. the object). Herein, the photoneutron source is not specifically limited, which can be, for example, a photoneutron source generated by a linear electron accelerator, or other photoneutron sources. Furthermore, the energy of the photoneutrons from the photoneutron source is preferably 1-10 MeV, but not limited to this range, which can be other energy ranges. Secondly, a detector that is located at a side of the detected object opposite to the photoneutron source receives the photoneutron rays from the photoneutron source (including the photoneutron rays that has transmitted the detected object and the photoneutron rays that has not successfully transmitted the detected object). As described above, the detector used herein can slow down and absorb the photoneutrons; for example, the detector is a detector that uses a scintillator containing neutron absorption nuclides (such as ¹⁰B, ⁶Li, ¹⁵⁵Gd or ¹⁵⁷Gd). However, the above contents are just examples, and the detector applicable to the present disclosure is not limited to the above examples, as long as it is able of slowing down and absorbing the neutrons. Finally, the detected object is imaged based on the photoneutron rays received by the detector, wherein the imaging method can be any imaging method in the prior art, which is not specifically limited in the disclosure. However, as previously described, it should be noted that the incidence direction of the photoneutron rays from the photoneutron source and the normal direction of the detector surface should form an angle within a predetermined range, for example, an angle of 78 degrees, in order to achieve the purpose of improving the resolution in the disclosure. But this is not a specific limitation, as long as the formed angle can achieve the effect that the absorption position is smaller than original absorption position after the absorption position is projected on the neutron incidence surface in the detector. In the disclosure, the angle is preferably in the range of 60 degrees to 87 degrees. Compared to the prior art, use of a combination of neutron moderator and neutron absorber can also reduce the resolution from 10 cm (caused by the slowing-down process) to, for example, about 2 cm.

Furthermore, the present disclosure is not limited to above described contents. As long as the angle formed between the incidence direction of the photoneutron rays and the normal direction of the detector surface falls within the above range (wherein the detector can slow down and absorb the photoneutrons), the other aspects of the present disclosure can be arbitrarily changed or combined.

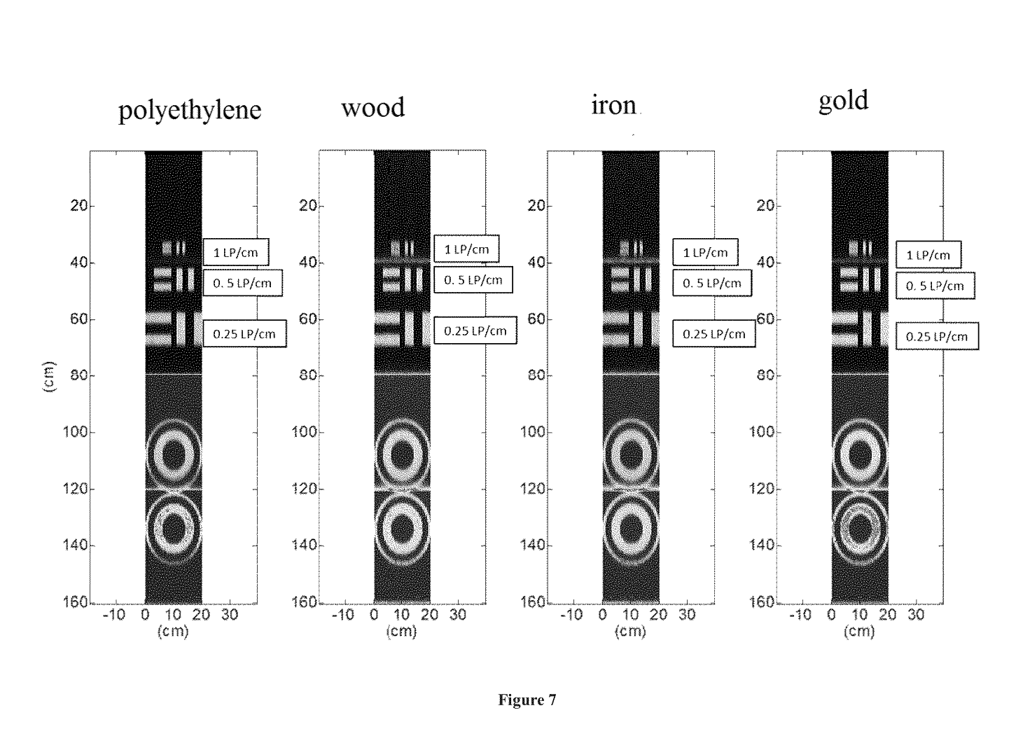

FIG. 7 is a schematic diagram illustrating simulation results of the position resolution of transmission imaging by four different materials (polyethylene, wood, iron and gold) obtained by the photoneutron detector of FIG. 6 according to an embodiment of the application. As can be seen, a line pair of 0.5 LP/cm can be distinguished, that is, a spatial position resolution of 2 cm can be achieved.

As described above, the present disclosure has been described by using various embodiments. But it is not limited to the above embodiments; it should be understood that various modification and equivalent substitution can be made within the spirit and principle of the application.

1. A method for imaging an object through photoneutron transmission, comprising:
emitting, by a photoneutron source, photoneutron rays to irradiate on the object;
receiving, by a detector, the photoneutron rays from the photoneutron source; and
imaging the object based on the photoneutron rays received by the detector;
wherein the detector can slow down and absorb the photoneutrons, and wherein the incidence direction of the photoneutron rays from the photoneutron source and the normal direction of the detector surface form an angle ranging from 60 degrees to 87 degrees.

2. The method according to claim 1, wherein the detector is a detector that uses a scintillator containing neutron absorption nuclides.

3. The method according to claim 2, wherein the absorption nuclides comprise ¹⁰B, ⁶Li, ¹⁵⁵Gd or ¹⁵⁷Gd.

4. The method according to claim 1, wherein the incidence direction of the photoneutron rays from the photoneutron source and the normal direction of the detector surface form an angle ranging from 70 degrees to 80 degrees.

5. The method according to claim 4, wherein the incidence direction of the photoneutron rays from the photoneutron source and the normal direction of the detector surface form an angle of 78 degrees.

6. The method according to claim 1, wherein the photoneutron source is a photoneutron source generated by a linear electron accelerator.

7. The method according to claim 1, wherein the photoneutron of the photoneutron source has an energy of 1-10 MeV.

8. The method according to claim 6, wherein the photoneutron of the photoneutron source has an energy of 1-10 MeV.

9. A device for imaging an object through photoneutron transmission, comprising:
a photoneutron source configured to emit photoneutron rays to irradiate on the object;
a detector configured to receive the photoneutron rays from the photoneutron source; and
an imaging system configured to image the object based on the photoneutron rays received by the detector;
wherein the detector can slow down and absorb the photoneutrons, and wherein the incidence direction of the photoneutron rays from the photoneutron source and the normal direction of the detector surface form an angle ranging from 60 degrees to 87 degrees.

10. The device according to claim 9, wherein the detector is a detector that uses a scintillator containing neutron absorption nuclides.

11. The device according to claim 10, wherein the absorption nuclides comprise ¹⁰B, ⁶Li, ¹⁵⁵Gd or ¹⁵⁷Gd.

12. The device according to claim 9, wherein the incidence direction of the photoneutron rays from the photoneutron source and the normal direction of the detector surface form an angle ranging from 70 degrees to 80 degrees.

13. The device according to claim 12, wherein the incidence direction of the photoneutron rays from the photoneutron source and the normal direction of the detector surface form an angle of 78 degrees.

14. The device according to claim 10, wherein the incidence direction of the photoneutron rays from the photoneutron source and the normal direction of the detector surface form an angle ranging from 70 degrees to 80 degrees.

15. The device according to claim 14, wherein the incidence direction of the photoneutron rays from the photoneutron source and the normal direction of the detector surface form an angle of 78 degrees.

16. The device according to claim 11, wherein the incidence direction of the photoneutron rays from the photoneutron source and the normal direction of the detector surface form an angle ranging from 70 degrees to 80 degrees.

17. The device according to claim 16, wherein the incidence direction of the photoneutron rays from the photoneutron source and the normal direction of the detector surface form an angle of 78 degrees.

18. The method according to claim 2, wherein the incidence direction of the photoneutron rays from the photoneutron source and the normal direction of the detector surface form an angle ranging from 70 degree to 80 degree.

19. The method according to claim 18, wherein the incidence direction of the photoneutron rays from the photoneutron source and the normal direction of the detector surface form an angle of about 78 degrees.

20. The method according to claim 3, wherein the incidence direction of the photoneutron rays from the photoneutron source and the normal direction of the detector surface form an angle ranging from 70 degree to 80 degree.

21. The method according to claim 20, wherein the incidence direction of the photoneutron rays from the photoneutron source and the normal direction of the detector surface form an angle of about 78 degrees.

22. The method according to claim 2, wherein the photoneutron source is a photoneutron source generated by a linear electron accelerator.

23. The method according to claim 22, wherein the photoneutron of the photoneutron source has an energy of 1-10 MeV.

24. The method according to claim 3, wherein the photoneutron source is a photoneutron source generated by a linear electron accelerator.

25. The method according to claim 22, wherein the photoneutron of the photoneutron source has an energy of 1-10 MeV.

26. The method according to claim 2, wherein the photoneutron of the photoneutron source has an energy of 1-10 MeV.

27. The method according to claim 3, wherein the photoneutron of the photoneutron source has an energy of 1-10 MeV.
